(19) United States
(12) Patent Application Publication
(10) Pub. No.: US 2024/0176670 A1
(43) Pub. Date: May 30, 2024

(54) VIRTUAL DISTRIBUTED ANTENNA SYSTEM ENHANCED HYPERSCALE VIRTUALIZATION

(71) Applicant: CommScope Technologies LLC, Claremont, NC (US)

(72) Inventors: Arjun Nanjundappa, Richardson, TX (US); Suresh N. Sriram, Bangalore (IN); Devaraj Sambandan, Bengaluru (IN); Ehsan Daeipour, Southborough, MA (US)

(73) Assignee: CommScope Technologies LLC, Claremont, NC (US)

(21) Appl. No.: 18/517,885

(22) Filed: Nov. 22, 2023

(30) Foreign Application Priority Data
Nov. 25, 2022 (IN) 202241067847

(51) Int. Cl. G06F 9/50

(52) U.S. Cl. CPC G06F 9/5044; G06F 9/505

(57) ABSTRACT

A computing system having a vDAS compute node implementing at least one virtual network function (NF) in a virtualized distributed antenna system (vDAS) having a plurality of radio units (RUs). The computing system includes server and vDAS compute node. The vDAS compute node includes vDAS container(s) running on a first subset of cores. The server: receives periodic capacity usage reports from the vDAS compute node(s); compares scaling metric data derived from the periodic capacity usage reports to threshold limits to determine if any threshold limits have been reached by any scaling metric data for the vDAS compute node; when any threshold limits have been reached by any scaling metric data for at least one vDAS compute node: cause vDAS compute node to scale capacity by either instantiating or deleting additional vDAS container on second subset of cores of the at least one vDAS compute node.

### CROSS-REFERENCE TO RELATED APPLICATIONS

This application claims the benefit of Indian Provisional Patent Application Serial No. 202241067847, filed on Nov. 25, 2022 and entitled “VIRTUAL DISTRIBUTED ANTENNA SYSTEM ENHANCED HYPERSCALE VIRTUALIZATION”, which is hereby incorporated herein by reference in its entirety.

### BACKGROUND

A distributed antenna system (DAS) typically includes one or more central units or nodes that are communicatively coupled to a plurality of remotely located access points or antenna units, where each access point can be coupled directly to one or more of the central access nodes or indirectly via one or more other remote units and/or via one or more intermediary or expansion units or nodes. A DAS can use either digital transport, analog transport, or combinations of digital and analog transport for generating and communicating the transport signals between the central access nodes, the access points, and any transport expansion nodes.

### SUMMARY

A computing system having a vDAS compute node implementing at least one virtual network function (NF) in a virtualized distributed antenna system (vDAS) having a plurality of radio units (RUS), the computing system comprising: at least one server having at least one processor; at least one vDAS compute node having at least one central processing unit with a plurality of cores, wherein the at least one vDAS compute node includes at least one vDAS container running on a first subset of the plurality of cores; wherein the at least one server is configured to: receive periodic capacity usage reports from the at least one vDAS compute node; compare scaling metric data derived from the periodic capacity usage reports to threshold limits to determine if any of the threshold limits have been reached by any of the scaling metric data for the at least one vDAS compute node; when any of the threshold limits have been reached by any of the scaling metric data for the at least one vDAS compute node: cause the at least one vDAS compute node to scale capacity by either instantiating or deleting at least one additional vDAS container on a second subset of the plurality of cores of the at least one vDAS compute node.

A method implemented in a virtualized distributed antenna system (vDAS) including at least one server and at least one vDAS compute node having a plurality of cores and implementing at least one virtual network function (NF) for at least one radio unit (RU) using at least one vDAS container running on a first subset of the plurality of cores, the method comprising: receiving periodic capacity usage reports for the at least one vDAS container at the at least one server from the at least one vDAS compute node; comparing scaling metric data derived from the periodic capacity usage reports to threshold limits to determine if any of the threshold limits have been reached by any of the scaling metric data for the at least one vDAS compute node; when any of the threshold limits have been reached by any of the scaling metric data for the at least one vDAS compute node: causing the at least one vDAS compute node to scale capacity of the at least one vDAS compute node by either instantiating or deleting at least one additional vDAS container on a second subset of the plurality of cores of the at least one vDAS compute node.

A non-transitory processor-readable medium on which program instructions, configured to be executed by at least one processor, are embodied, wherein when executed by the at least one processor, the program instructions cause the at least one processor to: receive, at at least one server from at least one vDAS compute node, periodic capacity usage reports for at least one virtualized distributed antenna system (vDAS) including at least one vDAS container operating on a first subset of a plurality of cores of the at least one vDAS compute node; compare scaling metric data derived from the periodic capacity usage reports to threshold limits to determine if any of the threshold limits have been reached by any of the scaling metric data for the at least one vDAS compute node; when any of the threshold limits have been reached by any of the scaling metric data for the at least one vDAS compute node: causing the at least one vDAS compute node to scale capacity of the at least one vDAS compute node by either instantiating or deleting at least one additional vDAS container on a second subset of the plurality of cores of the at least one vDAS compute node.

### BRIEF DESCRIPTION OF DRAWINGS

Understanding that the drawings depict only exemplary configurations and are not therefore to be considered limiting in scope, the exemplary configurations will be described with additional specificity and detail through the use of the accompanying drawings, in which:

FIGS. 1A-1D are block diagrams illustrating exemplary embodiments of distributed antenna systems (DAS).

FIG. 2 is an example block diagram of a vDAS Pod server.

FIGS. 3A-3B are example block diagrams showing a vDAS implementing scaling using a monolithic service architecture.

FIGS. 4A-4B are example block diagrams showing a vDAS implementing scaling using multiple micro-service architecture.

FIG. 5 is a flow diagram illustrating a method implemented in a virtualized distributed antenna system (vDAS) including at least one server and at least one vDAS compute node having a plurality of cores and implementing at least one virtual network function (NF) for at least one radio unit (RU) using at least one vDAS container running on a first subset of the plurality of cores.

FIG. 6 is an example block diagram showing a Kubernetes (k8s) Cluster for a system implementing autoscaling in hyperscaling platforms using Pods in Kubernetes.

In accordance with common practice, the various described features are not drawn to scale but are drawn to emphasize specific features relevant to the exemplary configurations.

### DETAILED DESCRIPTION

Example virtualized DAS (vDAS) systems are built on a Containerized Network Function (CNF) environment. In examples, the vDAS is implemented in a CNF environment with multiple containers supporting the vDAS functions being grouped into a computing entity and securely managed by each wireless operator. In examples, the vDAS application is built in Kubernetes virtualization environment with Pre-Orchestrated Pods deployed in commercial-off-the-shelf (COTS) hardware via Helm charts. In examples, Pods are the smallest deployable units of computing that you can create and manage in Kubernetes. In examples, a Pod is a Kubernetes abstraction that represents a group of one or more application containers and some shared resources for those containers. In examples, the shared resources may include shared storage (such as volumes), network (such as a unique cluster IP address), and/or information about how to run each container (such as the container image version or specific ports to use). In examples, a Pod models an application-specific “Logical host” and can contain different application containers which are relatively tightly coupled. In examples, a Pod runs on a Node (such as a virtual or physical machine) in Kubernetes. In other examples, application containers or other computing units are used instead of Kubernetes Pods.

In examples, there is a growing need in vDAS for varying radio units with different form factors, bandwidths, center frequencies fluctuating dynamically for spikes in network traffic during busy hours and in maintenance mode during low traffic mode. This can give rise to vDAS being flexible in capacity to different traffic scenarios to help mobile network operators (MNOs) with investment protection and increased efficiency, can enable multi-operator O-RAN traffic modes, and can improve calls for scaling-in, scaling-out, scaling-up, and scaling-down of the DAS nodes based on fluctuating network traffic modes spanning across different deployment scenarios.

In examples, a flexible platform supports different scenarios (transportation, venues and enterprises). Further, the scalable network interfaces address future traffic demand, such as 10 Gbps, 25 Gbps, 100 Gbps, 200 Gbps, and higher. Additionally, software upgradability enables easier addition of value added features (e.g. UL noise muting). In examples, virtualized software runs on COTS hardware, which enables deployment on any hyperscale environment (such as Amazon AWS environment, Microsoft Azure environment, Google Cloud environment, etc.). In examples, end-to-end O-RAN support is enabled. In examples, multi-operator is supported in a single deployment scenario. In examples, the fronthaul gateway and fronthaul multiplexer are supported and can be scaled based on requirements in a specific scenario so we can handle an increase in traffic across diverse operator environment. In examples, a third party O-RAN remote unit is supported on any hardware and different hardware from different vendors can be used together. In examples, there is native O-RAN FHGW & FHM support, native O-RAN Shared RU support, and/or RF Interface support. In examples, efficiency is increased as interference is lower with intelligent pseudorandom binary sequence (PRBS) transmission and uplink performance is increased with noise muting. In examples, higher performance is supported over both the existing operator environment and in a private side network on a cloud-run architecture. In examples based upon Cloud RAN architecture, the software can be upgraded for RAN workloads and includes full fronthaul and radio infrastructure reuse.

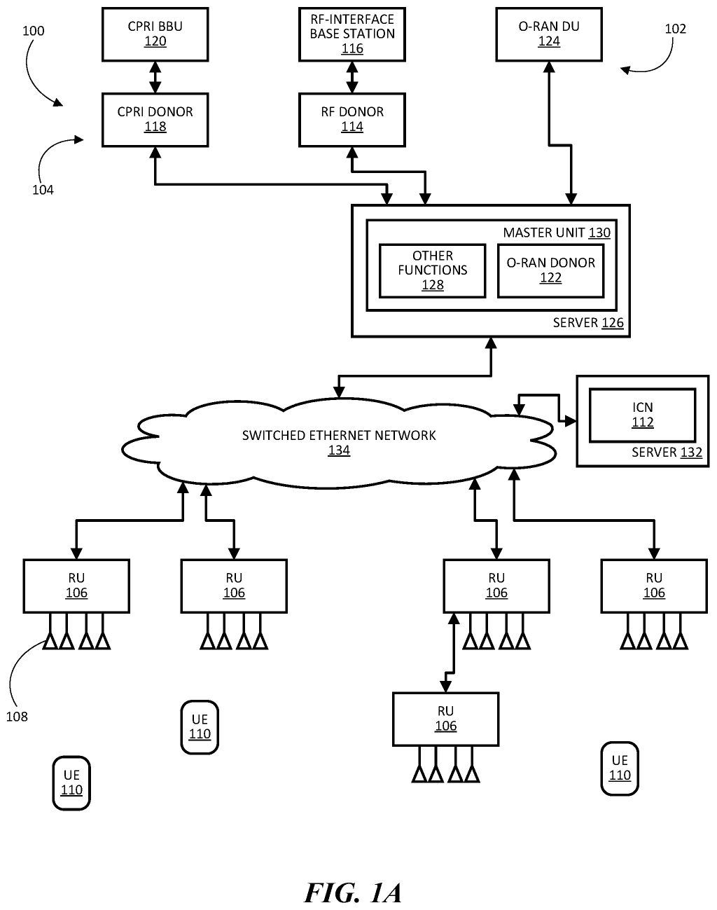

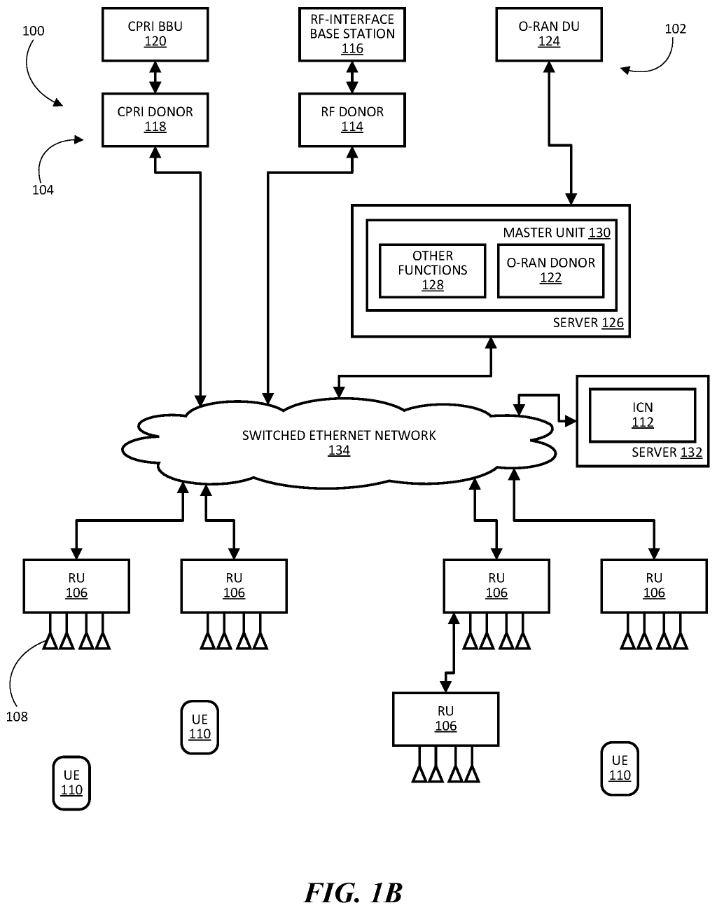

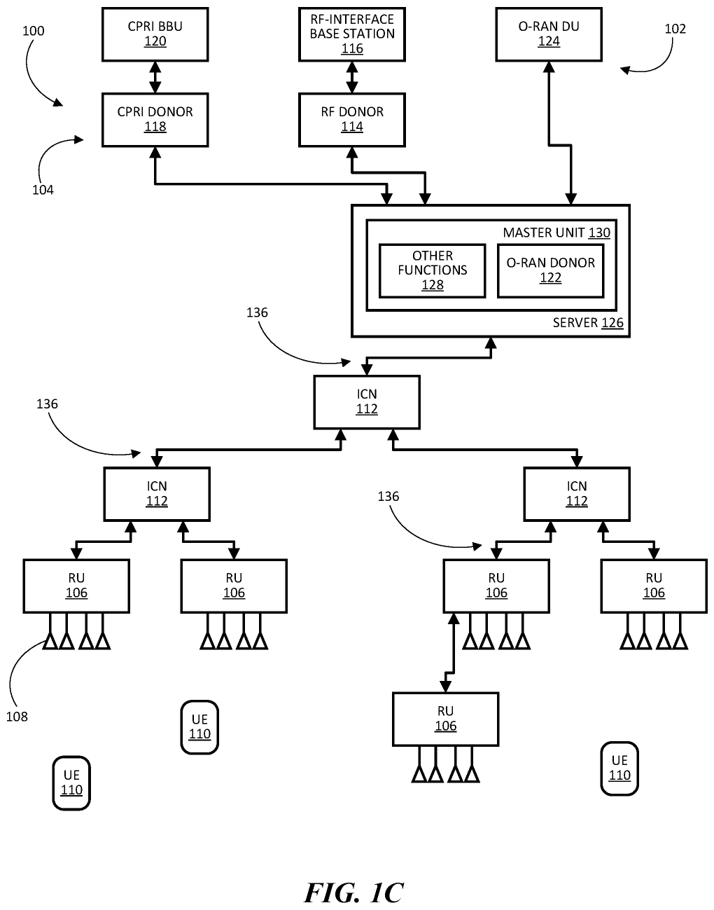

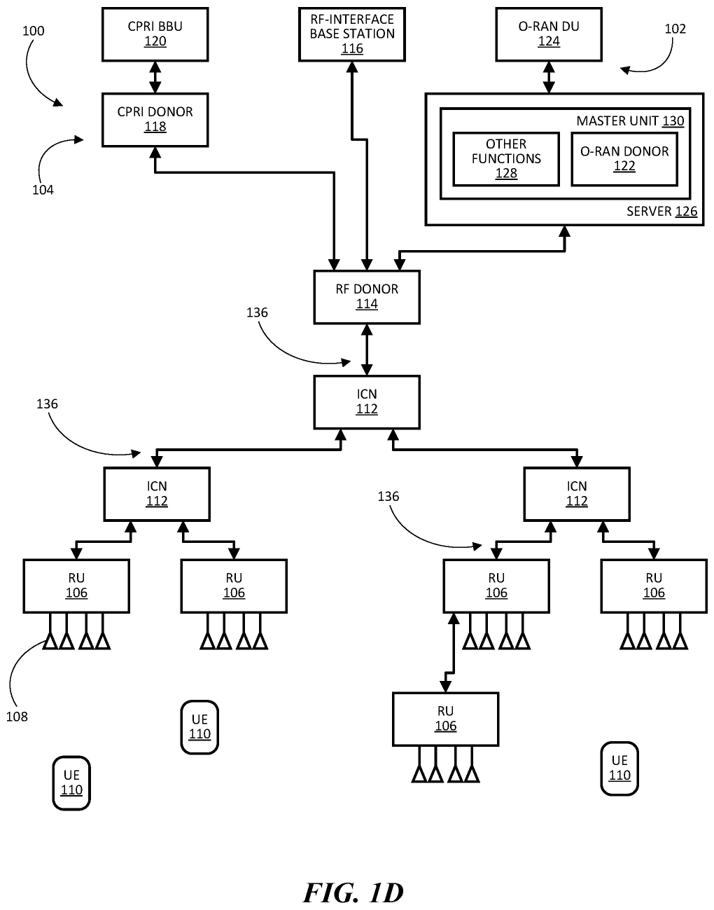

FIG. 1A is a block diagram illustrating an exemplary embodiment of a distributed antenna system (DAS) 100 that is configured to serve one or more base stations 102. In the exemplary embodiment shown in FIG. 1A, the DAS 100 includes one or more donor units 104 that are used to couple the DAS 100 to the base stations 102. The DAS 100 also includes a plurality of remotely located radio units (RUs) 106 (also referred to as “antenna units,” “access points,” “remote units,” or “remote antenna units”). The RUs 106 are communicatively coupled to the donor units 104.

Each RU 106 includes, or is otherwise associated with, a respective set of coverage antennas 108 via which downlink analog RF signals can be radiated to user equipment (UEs) 110 and via which uplink analog RF signals transmitted by UEs 110 can be received. The DAS 100 is configured to serve each base station 102 using a respective subset of RUs 106 (which may include less than all of the RUs 106 of the DAS 100). Also, the subsets of RUs 106 used to serve the base stations 102 may differ from base station 102 to base station 102. The subset of RUs points 106 used to serve a given base station 102 is also referred to here as the “simulcast zone” for that base station 102. In general, the wireless coverage of a base station 102 served by the DAS 100 is improved by radiating a set of downlink RF signals for that base station 102 from the coverage antennas 108 associated with the multiple RUs 106 in that base station's simulcast zone and by producing a single “combined” set of uplink base station signals or data that is provided to that base station 102. The single combined set of uplink base station signals or data is produced by a combining or summing process that uses inputs derived from the uplink RF signals received via the coverage antennas 108 associated with the RUs 106 in that base station's simulcast zone.

The DAS 100 can also include one or more intermediary combining nodes (ICNs) 112 (also referred to as “expansion” units or nodes). For each base station 102 served by a given ICN 112, the ICN 112 is configured to receive a set of uplink transport data for that base station 102 from a group of “southbound” entities (that is, from RUs 106 and/or other ICNs 112) and generate a single set of combined uplink transport data for that base station 102, which the ICN 112 transmits “northbound” towards the donor unit 104 serving that base station 102. The single set of combined uplink transport data for each served base station 102 is produced by a combining or summing process that uses inputs derived from the uplink RF signals received via the coverage antennas 108 of any southbound RUs 106 included in that base station's simulcast zone. As used here, “southbound” refers to traveling in a direction “away,” or being relatively “farther,” from the donor units 104 and base stations 102, and “northbound” refers to traveling in a direction “towards”, or being relatively “closer” to, the donor units 104 and base stations 102.

In some configurations, each ICN 112 also forwards downlink transport data to the group of southbound RUs 108s and/or ICNs 112 served by that ICN 112. Generally, ICNs 112 can be used to increase the number of RUs 106 that can be served by the donor units 104 while reducing the processing and bandwidth load relative to having the additional RUs 106 communicate directly with each such donor unit 104.

Also, one or more RUs 106 can be configured in a “daisy-chain” or “ring” configuration in which transport data for at least some of those RUs 106 is communicated via at least one other RU 106. Each RU 106 would also perform the combining or summing process for any base station 102 that is served by that RU 106 and one or more of the southbound entities subtended from that RU 106. (Such a RU 106 also forwards northbound all other uplink transport data received from its southbound entities.)

The DAS 100 can include various types of donor units 104. One example of a donor unit 104 is an RF donor unit 114 that is configured to couple the DAS 100 to a base station 116 using the external analog radio frequency (RF) interface of the base station 116 that would otherwise be used to couple the base station 116 to one or more antennas (if the DAS 100 were not being used). This type of base station 116 is also referred to here as an “RF-interface” base station 116. An RF-interface base station 116 can be coupled to a corresponding RF donor unit 114 by coupling each antenna port of the base station 116 to a corresponding port of the RF donor unit 114.

Each RF donor unit 114 serves as an interface between each served RF-interface base station 116 and the rest of the DAS 100 and receives downlink base station signals from, and outputs uplink base station signals to, each served RF-interface base station 116. Each RF donor unit 114 performs at least some of the conversion processing necessary to convert the base station signals to and from the digital fronthaul interface format natively used in the DAS 100 for communicating time-domain baseband data. The downlink and uplink base station signals communicated between the RF-interface base station 116 and the donor unit 114 are analog RF signals. Also, in this example, the digital fronthaul interface format natively used in the DAS 100 for communicating time-domain baseband data can comprise the O-RAN fronthaul interface, a CPRI or enhanced CPRI (cCPRI) digital fronthaul interface format, or a proprietary digital fronthaul interface format (though other digital fronthaul interface formats can also be used).

Another example of a donor unit 104 is a digital donor unit that is configured to communicatively couple the DAS 100 to a baseband entity using a digital baseband fronthaul interface that would otherwise be used to couple the baseband entity to a radio unit (if the DAS 100 were not being used). In the example shown in FIG. 1A, two types of digital donor units are shown.

The first type of digital donor unit comprises a digital donor unit 118 that is configured to communicatively couple the DAS 100 to a baseband unit (BBU) 120 using a time-domain baseband fronthaul interface implemented in accordance with a Common Public Radio Interface (“CPRI”) specification. This type of digital donor unit 118 is also referred to here as a “CPRI” donor unit 118, and this type of BBU 120 is also referred to here as a CPRI BBU 120. For each CPRI BBU 120 served by a CPRI donor unit 118, the CPRI donor unit 118 is coupled to the CPRI BBU 120 using the CPRI digital baseband fronthaul interface that would otherwise be used to couple the CPRI BBU 120 to a CPRI remote radio head (RRH) (if the DAS 100 were not being used). A CPRI BBU 120 can be coupled to a corresponding CPRI donor unit 118 via a direct CPRI connection.

Each CPRI donor unit 118 serves as an interface between each served CPRI BBU 120 and the rest of the DAS 100 and receives downlink base station signals from, and outputs uplink base station signals to, each CPRI BBU 120. Each CPRI donor unit 118 performs at least some of the conversion processing necessary to convert the CPRI base station data to and from the digital fronthaul interface format natively used in the DAS 100 for communicating time-domain baseband data. The downlink and uplink base station signals communicated between each CPRI BBU 120 and the CPRI donor unit 118 comprise downlink and uplink fronthaul data generated and formatted in accordance with the CPRI baseband fronthaul interface.

The second type of digital donor unit comprises a digital donor unit 122 that is configured to communicatively couple the DAS 100 to a BBU 124 using a frequency-domain baseband fronthaul interface implemented in accordance with a O-RAN Alliance specification. The acronym “O-RAN” is an abbreviation for “Open Radio Access Network.” This type of digital donor unit 122 is also referred to here as an “O-RAN” donor unit 122, and this type of BBU 124 is typically an O-RAN distributed unit (DU) and is also referred to here as an O-RAN DU 124. For each O-RAN DU 124 served by a O-RAN donor unit 122, the O-RAN donor unit 122 is coupled to the O-RAN DU 124 using the O-RAN digital baseband fronthaul interface that would otherwise be used to couple the O-RAN DU 124 to a O-RAN RU (if the DAS 100 were not being used). An O-RAN DU 124 can be coupled to a corresponding O-RAN donor unit 122 via a switched Ethernet network. Alternatively, an O-RAN DU 124 can be coupled to a corresponding O-RAN donor unit 122 via a direct Ethernet or CPRI connection.

Each O-RAN donor unit 122 serves as an interface between each served O-RAN DU 124 and the rest of the DAS 100 and receives downlink base station signals from, and outputs uplink base station signals to, each O-RAN DU 124. Each O-RAN donor unit 122 performs at least some of any conversion processing necessary to convert the base station signals to and from the digital fronthaul interface format natively used in the DAS 100 for communicating frequency-domain baseband data. The downlink and uplink base station signals communicated between each O-RAN DU 124 and the O-RAN donor unit 122 comprise downlink and uplink fronthaul data generated and formatted in accordance with the O-RAN baseband fronthaul interface, where the user-plane data comprises frequency-domain baseband IQ data. Also, in this example, the digital fronthaul interface format natively used in the DAS 100 for communicating O-RAN fronthaul data is the same O-RAN fronthaul interface used for communicating base station signals between each O-RAN DU 124 and the O-RAN donor unit 122, and the “conversion” performed by each O-RAN donor unit 122 (and/or one or more other entities of the DAS 100) includes performing any needed “multicasting” of the downlink data received from each O-RAN DU 124 to the multiple RUs 106 in a simulcast zone for that O-RAN DU 124 (for example, by communicating the downlink fronthaul data to an appropriate multicast address and/or by copying the downlink fronthaul data for communication over different fronthaul links) and performing any needed combining or summing of the uplink data received from the RUs 106 to produce combined uplink data provided to the O-RAN DU 124. It is to be understood that other digital fronthaul interface formats can also be used.

In general, the various base stations 102 are configured to communicate with a core network (not shown) of the associated wireless operator using an appropriate backhaul network (typically, a public wide area network such as the Internet). Also, the various base stations 102 may be from multiple, different wireless operators and/or the various base stations 102 may support multiple, different wireless protocols and/or RF bands.

In general, for each base station 102, the DAS 100 is configured to receive a set of one or more downlink base station signals from the base station 102 (via an appropriate donor unit 104), generate downlink transport data derived from the set of downlink base station signals, and transmit the downlink transport data to the RUs 106 in the base station's simulcast zone. For each base station 102 served by a given RU 106, the RU 106 is configured to receive the downlink transport data transmitted to it via the base station 102 and use the received downlink transport data to generate one or more downlink analog radio frequency signals that are radiated from one or more coverage antennas 108 associated with that RU 106 for reception by user equipment 110. In this way, the DAS 100 increases the coverage area for the downlink capacity provided by the base stations 102. Also, for any southbound entities (for example, southbound RUs 106 or ICNs 112) coupled to the RU 106 (for example, in a daisy chain or ring architecture), the RU 106 forwards any downlink transport data intended for those southbound entities towards them.

For each base station 102 served by a given RU 106, the RU 106 is configured to receive one or more uplink radio frequency signals transmitted from the user equipment 110. These signals are analog radio frequency signals and are received via the coverage antennas 108 associated with that RU 106. The RU 106 is configured to generate uplink transport data derived from the one or more remote uplink radio frequency signals received for the served base station 102 and transmit the uplink transport data northbound towards the donor unit 104 coupled to that base station 102.

For each base station 102 served by the DAS 100, a single “combined” set of uplink base station signals or data is produced by a combining or summing process that uses inputs derived from the uplink RF signals received via the RUs 106 in that base station's simulcast zone. The resulting final single combined set of uplink base station signals or data is provided to the base station 102. This combining or summing process can be performed in a centralized manner in which the combining or summing process is performed by a single unit of the DAS 100 (for example, a donor unit 104 or master unit 130). This combining or summing process can also be performed in a distributed or hierarchical manner in which the combining or summing process is performed by multiple units of the DAS 100 (for example, a donor unit 104 (or master unit 130) and one or more ICNs 112 and/or RUs 106). Each unit of the DAS 100 that performs the combining or summing process for a given base station 102 receives uplink transport data from that unit's southbound entities and uses that data to generate combined uplink transport data, which the unit transmits northbound towards the base station 102. The generation of the combined uplink transport data involves, among other things, extracting in-phase and quadrature (IQ) data from the received uplink transport data and performing a combining or summing process using any uplink IQ data for that base station 102 in order to produce combined uplink IQ data.

Some of the details regarding how base station signals or data are communicated and transport data is produced vary based on which type of base station 102 is being served. In the case of an RF-interface base station 116, the associated RF donor unit 114 receives analog downlink RF signals from the RF-interface base station 116 and, either alone or in combination with one or more other units of the DAS 100, converts the received analog downlink RF signals to the digital fronthaul interface format natively used in the DAS 100 for communicating time-domain baseband data (for example, by digitizing, digitally down-converting, and filtering the received analog downlink RF signals in order to produce digital baseband IQ data and formatting the resulting digital baseband IQ data into packets) and communicates the resulting packets of downlink transport data to the various RUs 106 in the simulcast zone of that base station 116. The RUs 106 in the simulcast zone for that base station 116 receive the downlink transport data and use it to generate and radiate downlink RF signals as described above. In the uplink, either alone or in combination with one or more other units of the DAS 100, the RF donor unit 114 generates a set of uplink base station signals from uplink transport data received by the RF donor unit 114 (and/or the other units of the DAS 100 involved in this process). The set of uplink base station signals is provided to the served base station 116. The uplink transport data is derived from the uplink RF signals received at the RUs 106 in the simulcast zone of the served base station 116 and communicated in packets.

In the case of a CPRI BBU 120, the associated CPRI digital donor unit 118 receives CPRI downlink fronthaul data from the CPRI BBU 120 and, either alone or in combination with another unit of the DAS 100, converts the received CPRI downlink fronthaul data to the digital fronthaul interface format natively used in the DAS 100 for communicating time-domain baseband data (for example, by re-sampling, synchronizing, combining, separating, gain adjusting, etc. the CPRI baseband IQ data, and formatting the resulting baseband IQ data into packets), and communicates the resulting packets of downlink transport data to the various RUs 106 in the simulcast zone of that CPRI BBU 120. The RUs 106 in the simulcast zone of that CPRI BBU 120 receive the packets of downlink transport data and use them to generate and radiate downlink RF signals as described above. In the uplink, either alone or in combination with one or more other units of the DAS 100, the CPRI donor unit 118 generates uplink base station data from uplink transport data received by the CPRI donor unit 118 (and/or the other units of the DAS 100 involved in this process). The resulting uplink base station data is provided to that CPRI BBU 120. The uplink transport data is derived from the uplink RF signals received at the RUs 106 in the simulcast zone of the CPRI BBU 120.

In the case of an O-RAN DU 124, the associated O-RAN donor unit 122 receives packets of O-RAN downlink fronthaul data (that is, O-RAN user-plane and control-plane messages) from each O-RAN DU 124 coupled to that O-RAN digital donor unit 122 and, cither alone or in combination with another unit of the DAS 100, converts (if necessary) the received packets of O-RAN downlink fronthaul data to the digital fronthaul interface format natively used in the DAS 100 for communicating O-RAN baseband data and communicates the resulting packets of downlink transport data to the various RUs 106 in a simulcast zone for that ORAN DU 124. The RUs 106 in the simulcast zone of each O-RAN DU 124 receive the packets of downlink transport data and use them to generate and radiate downlink RF signals as described above. In the uplink, either alone or in combination with one or more other units of the DAS 100, the O-RAN donor unit 122 generates packets of uplink base station data from uplink transport data received by the O-RAN donor unit 122 (and/or the other units of the DAS 100 involved in this process). The resulting packets of uplink base station data are provided to the O-RAN DU 124. The uplink transport data is derived from the uplink RF signals received at the RUs 106 in the simulcast zone of the served O-RAN DU 124 and communicated in packets.

In one implementation, one of the units of the DAS 100 is also used to implement a “master” timing entity for the DAS 100 (for example, such a master timing entity can be implemented as a part of a master unit 130 described below). In another example, a separate, dedicated timing master entity (not shown) is provided within the DAS 100. In either case, the master timing entity synchronizes itself to an external timing master entity (for example, a timing master associated with one or more of the O-RAN DUs 124) and, in turn, that entity serves as a timing master entity for the other units of the DAS 100. A time synchronization protocol (for example, the Institute of Electrical and Electronics Engineers (IEEE) 1588 Precision Time Protocol (PTP), the Network Time Protocol (NTP), or the Synchronous Ethernet (SyncE) protocol) can be used to implement such time synchronization.

A management system (not shown) can be used to manage the various nodes of the DAS 100. In one implementation, the management system communicates with a predetermined “master” entity for the DAS 100 (for example, the master unit 130 described below), which in turns forwards or otherwise communicates with the other units of the DAS 100 for management-plane purposes. In another implementation, the management system communicates with the various units of the DAS 100 directly for management-plane purposes (that is, without using a master entity as a gateway).

Each base station 102 (including each RF-interface base station 116, CPRI BBU 120, and O-RAN DU 124), donor unit 104 (including each RF donor unit 114, CPRI donor unit 118, and O-RAN donor unit 122), RU 106, ICN 112, and any of the specific features described here as being implemented thereby, can be implemented in hardware, software, or combinations of hardware and software, and the various implementations (whether hardware, software, or combinations of hardware and software) can also be referred to generally as “circuitry,” a “circuit,” or “circuits” that is or are configured to implement at least some of the associated functionality. When implemented in software, such software can be implemented in software or firmware executing on one or more suitable programmable processors (or other programmable device) or configuring a programmable device (for example, processors or devices included in or used to implement special-purpose hardware, general-purpose hardware, and/or a virtual platform). In such a software example, the software can comprise program instructions that are stored (or otherwise embodied) on or in an appropriate non-transitory processor-readable medium or media (such as flash or other non-volatile memory, magnetic disc drives, and/or optical disc drives) from which at least a portion of the program instructions are read by the programmable processor or device for execution thereby (and/or for otherwise configuring such processor or device) in order for the processor or device to perform one or more functions described here as being implemented by the software. Such hardware or software (or portions thereof) can be implemented in other ways (for example, in an application specific integrated circuit (ASIC), field programmable gate array (FPGA), etc.). Such entities can be implemented in other ways.

The DAS 100 can be implemented in a virtualized manner or a non-virtualized manner. When implemented in a virtualized manner, one or more nodes, units, or functions of the DAS 100 are implemented using one or more virtual network functions (VNFs) executing on one or more physical server computers (also referred to here as “physical servers” or just “servers”) (for example, one or more commercial-off-the-shelf (COTS) servers of the type that are deployed in data centers or “clouds” maintained by enterprises, communication service providers, or cloud services providers). More specifically, in the exemplary embodiment shown in FIG. 1A, each O-RAN donor unit 122 is implemented as a VNF running on a server 126. The server 126 can execute other VNFs 128 that implement other functions for the DAS 100 (for example, fronthaul, management plane, and synchronization plane functions). The various VNFs executing on the server 126 are also referred to here as “master unit” functions 130 or, collectively, as the “master unit” 130. Also, in the exemplary embodiment shown in FIG. 1A, each ICN 112 is implemented as a VNF running on a server 132.

The RF donor units 114 and CPRI donor units 118 can be implemented as cards (for example, Peripheral Component Interconnect (PCI) Cards) that are inserted in the server 126. Alternatively, the RF donor units 114 and CPRI donor units 118 can be implemented as separate devices that are coupled to the server 126 via dedicated Ethernet links or via a switched Ethernet network (for example, the switched Ethernet network 134 described below).

In the exemplary embodiment shown in FIG. 1A, the donor units 104, RUs 106 and ICNs 112 are communicatively coupled to one another via a switched Ethernet network 134. Also, in the exemplary embodiment shown in FIG. 1A, an O-RAN DU 124 can be coupled to a corresponding O-RAN donor unit 122 via the same switched Ethernet network 134 used for communication within the DAS 100 (though each O-RAN DU 124 can be coupled to a corresponding O-RAN donor unit 122 in other ways). In the exemplary embodiment shown in FIG. 1A, the downlink and uplink transport data communicated between the units of the DAS 100 is formatted as O-RAN data that is communicated in Ethernet packets over the switched Ethernet network 134.

In the exemplary embodiment shown in FIG. 1A, the RF donor units 114 and CPRI donor units 118 are coupled to the RUs 106 and ICNs 112 via the master unit 130.

In the downlink, the RF donor units 114 and CPRI donor units 118 provide downlink time-domain baseband IQ data to the master unit 130. The master unit 130 generates downlink O-RAN user-plane messages containing downlink baseband IQ that is either the time-domain baseband IQ data provided from the donor units 114 and 118 or is derived therefrom (for example, where the master unit 130 converts the received time-domain baseband IQ data into frequency-domain baseband IQ data). The master unit 130 also generates corresponding downlink O-RAN control-plane messages for those O-RAN user-plane messages. The resulting downlink O-RAN user-plane and control-plane messages are communicated (multicasted) to the RUs 106 in the simulcast zone of the corresponding base station 102 via the switched Ethernet network 134.

In the uplink, for each RF-interface base station 116 and CPRI BBU 120, the master unit 130 receives O-RAN uplink user-plane messages for the base station 116 or CPRI BBU 120 and performs a combining or summing process using the uplink baseband IQ data contained in those messages in order to produce combined uplink baseband IQ data, which is provided to the appropriate RF donor unit 114 or CPRI donor unit 118. The RF donor unit 114 or CPRI donor unit 118 uses the combined uplink baseband IQ data to generate a set of base station signals or CPRI data that is communicated to the corresponding RF-interface base station 116 or CPRI BBU 120. If time-domain baseband IQ data has been converted into frequency-domain baseband IQ data for transport over the DAS 100, the donor unit 114 or 118 also converts the combined uplink frequency-domain IQ data into combined uplink time-domain IQ data as part of generating the set of base station signals or CPRI data that is communicated to the corresponding RF-interface base station 116 or CPRI BBU 120.

In the exemplary embodiment shown in FIG. 1A, the master unit 130 (more specifically, the O-RAN donor unit 122) receives downlink O-RAN user-plane and control-plane messages from each served O-RAN DU 124 and communicates (multicasts) them to the RUs 106 in the simulcast zone of the corresponding O-RAN DU 124 via the switched Ethernet network 134. In the uplink, the master unit 130 (more specifically, the O-RAN donor unit 122) receives O-RAN uplink user-plane messages for each served O-RAN DU 124 and performs a combining or summing process using the uplink baseband IQ data contained in those messages in order to produce combined uplink IQ data. The O-RAN donor unit 122 produces O-RAN uplink user-plane messages containing the combined uplink baseband IQ data and communicates those messages to the O-RAN DU 124.

In the exemplary embodiment shown in FIG. 1A, only uplink transport data is communicated using the ICNs 112, and downlink transport data is communicated from the master unit 130 to the RUs 106 without being forwarded by, or otherwise communicated using, the ICNs 112.

FIG. 1B illustrates another exemplary embodiment of a DAS 100. The DAS 100 shown in FIG. 1B is the same as the DAS 100 shown in FIG. 1A except as described below. In the exemplary embodiment shown in FIG. 1B, the RF donor unit 114 and CPRI donor unit 118 are coupled directly to the switched Ethernet network 134 and not via the master unit 130, as is the case in the embodiment shown in FIG. 1A.

As described above, in the exemplary embodiment shown in FIG. 1A, the master unit 130 performs some transport functions related to serving the RF-interface base stations 116 and CPRI BBUs 120 coupled to the donor units 114 and 118. In the exemplary embodiment shown in FIG. 1B, the RF donor units 114 and CPRI donor units 118 perform those transport functions (that is, the RF donor units 114 and CPRI donor units 118 perform all of the transport functions related to serving the RF-interface base stations 116 and CPRI BBUs 120, respectively).

FIG. 1C illustrates another exemplary embodiment of a DAS 100. The DAS 100 shown in FIG. 1C is the same as the DAS 100 shown in FIG. 1A except as described below. In the exemplary embodiment shown in FIG. 1C, the donor units 104, RUs 106 and ICNs 112 are communicatively coupled to one another via point-to-point Ethernet links 136 (instead of a switched Ethernet network). Also, in the exemplary embodiment shown in FIG. 1C, an O-RAN DU 124 can be coupled to a corresponding O-RAN donor unit 122 via a switched Ethernet network (not shown in FIG. 1C), though that switched Ethernet network is not used for communication within the DAS 100. In the exemplary embodiment shown in FIG. 1C, the downlink and uplink transport data communicated between the units of the DAS 100 is communicated in Ethernet packets over the point-to-point Ethernet links 136.

For each southbound point-to-point Ethernet link 136 that couples a master unit 130 to an ICN 112, the master unit 130 assembles downlink transport frames and communicates them in downlink Ethernet packets to the ICN 112 over the point-to-point Ethernet link 136. For each point-to-point Ethernet link 136, each downlink transport frame multiplexes together downlink time-domain baseband IQ data and Ethernet data that needs to be communicated to southbound RUs 106 and ICNs 112 that are coupled to the master unit 130 via that point-to-point Ethernet link 136. The downlink time-domain baseband IQ data is sourced from one or more RF donor units 114 and/or CPRI donor units 118. The Ethernet data comprises downlink user-plane and control-plane O-RAN fronthaul data sourced from one or more O-RAN donor units 122 and/or management-plane data sourced from one or more management entities for the DAS 100. That is, this Ethernet data is encapsulated into downlink transport frames that are also used to communicate downlink time-domain baseband IQ data and this Ethernet data is also referred to here as “encapsulated” Ethernet data. The resulting downlink transport frames are communicated in the payload of downlink Ethernet packets communicated from the master unit 130 to the ICN 112 over the point-to-point Ethernet link 136. The Ethernet packets into which the encapsulated Ethernet data is encapsulated are also referred to here as “transport” Ethernet packets.

Each ICN 112 receives downlink transport Ethernet packets via each northbound point-to-point Ethernet link 136 and extracts any downlink time-domain baseband IQ data and/or encapsulated Ethernet data included in the downlink transport frames communicated via the received downlink transport Ethernet packets. Any encapsulated Ethernet data that is intended for the ICN 112 (for example, management-plane Ethernet data) is processed by the ICN 112.

For each southbound point-to-point Ethernet link 136 coupled to the ICN 112, the ICN 112 assembles downlink transport frames and communicates them in downlink Ethernet packets to the southbound entities subtended from the ICN 112 via the point-to-point Ethernet link 136. For each southbound point-to-point Ethernet link 136, each downlink transport frame multiplexes together downlink time-domain baseband IQ data and Ethernet data received at the ICN 112 that needs to be communicated to those subtended southbound entities. The resulting downlink transport frames are communicated in the payload of downlink transport Ethernet packets communicated from the ICN 112 to those subtended southbound entities ICN 112 over the point-to-point Ethernet link 136.

Each RU 106 receives downlink transport Ethernet packets via each northbound point-to-point Ethernet link 136 and extracts any downlink time-domain baseband IQ data and/or encapsulated Ethernet data included in the downlink transport frames communicated via the received downlink transport Ethernet packets. As described above, the RU 106 uses any downlink time-domain baseband IQ data and/or downlink O-RAN user-plane and control-plane fronthaul messages to generate downlink RF signals for radiation from the set of coverage antennas 108 associated with that RU 106. The RU 106 processes any management-plane messages communicated to that RU 106 via encapsulated Ethernet data.

Also, for any southbound point-to-point Ethernet link 136 coupled to the RU 106, the RU 106 assembles downlink transport frames and communicates them in downlink Ethernet packets to the southbound entities subtended from the RU 106 via the point-to-point Ethernet link 136. For each southbound point-to-point Ethernet link 136, each downlink transport frame multiplexes together downlink time-domain baseband IQ data and Ethernet data received at the RU 106 that needs to be communicated to those subtended southbound entities. The resulting downlink transport frames are communicated in the payload of downlink transport Ethernet packets communicated from the RU 106 to those subtended southbound entities ICN 112 over the point-to-point Ethernet link 136.

In the uplink, each RU 106 generates uplink time-domain baseband IQ data and/or uplink O-RAN user-plane fronthaul messages for each RF-interface base station 116, CPRI BBU 120, and/or O-RAN DU 124 served by that RU 106 as described above. For each northbound point-to-point Ethernet link 136 of the RU 106, the RU 106 assembles uplink transport frames and communicates them in uplink transport Ethernet packets northbound towards the appropriate master unit 130 via that point-to-point Ethernet link 136. For each northbound point-to-point Ethernet link 136, each uplink transport frame multiplexes together uplink time-domain baseband IQ data originating from that RU 106 and/or any southbound entity subtended from that RU 106 as well as any Ethernet data originating from that RU 106 and/or any southbound entity subtended from that RU 106. In connection with doing this, the RU 106 performs the combining or summing process described above for any base station 102 served by that RU 106 and also by one or more of the subtended entities. (The RU 106 forwards northbound all other uplink data received from those southbound entities.) The resulting uplink transport frames are communicated in the payload of uplink transport Ethernet packets northbound towards the master unit 130 via the associated point-to-point Ethernet link 136.

Each ICN 112 receives uplink transport Ethernet packets via each southbound point-to-point Ethernet link 136 and extracts any uplink time-domain baseband IQ data and/or encapsulated Ethernet data included in the uplink transport frames communicated via the received uplink transport Ethernet packets. For each northbound point-to-point Ethernet link 136 coupled to the ICN 112, the ICN 112 assembles uplink transport frames and communicates them in uplink transport Ethernet packets northbound towards the master unit 130 via that point-to-point Ethernet link 136. For each northbound point-to-point Ethernet link 136, each uplink transport frame multiplexes together uplink time-domain baseband IQ data and Ethernet data received at the ICN 112 that needs to be communicated northbound towards the master unit 130. The resulting uplink transport frames are communicated in the payload of uplink transport Ethernet packets communicated northbound towards the master unit 130 over the point-to-point Ethernet link 136.

Each master unit 130 receives uplink transport Ethernet packets via each southbound point-to-point Ethernet link 136 and extracts any uplink time-domain baseband IQ data and/or encapsulated Ethernet data included in the uplink transport frames communicated via the received uplink transport Ethernet packets. Any extracted uplink time-domain baseband IQ data, as well as any uplink O-RAN messages communicated in encapsulated Ethernet, is used in producing a single “combined” set of uplink base station signals or data for the associated base station 102 as described above (which includes performing the combining or summing process). Any other encapsulated Ethernet data (for example, management-plane Ethernet data) is forwarded on towards the respective destination (for example, a management entity).

In the exemplary embodiment shown in FIG. 1C, synchronization-plane messages are communicated using native Ethernet packets (that is, non-encapsulated Ethernet packets) that are interleaved between the transport Ethernet packets.

FIG. 1D illustrates another exemplary embodiment of a DAS 100. The DAS 100 shown in FIG. 1C is the same as the DAS 100 shown in FIG. 1C except as described below. In the exemplary embodiment shown in FIG. 1D, the CPRI donor units 118, O-RAN donor unit 122, and master unit 130 are coupled to the RUs 106 and ICNs 112 via one or more RF donor units 114. That is, each RF donor unit 114 performs the transport frame multiplexing and demultiplexing that is described above in connection with FIG. 1C as being performed by the master unit 130.

When the DAS 100 of any of FIGS. 1A-1D is virtualized as a virtualized DAS (vDAS) 100, virtualization software is executed to implement at least one virtual network function (VNF) running on a server 126. While a single server 126 is shown, it is understood that the at least one virtual network function (VNF) can be implemented using any number of physical servers 126 and that these physical servers can be commercial-off-the-shelf (COTS) hardware. In this description, it should be understood that references to “virtualization” are intended to refer to, and include within their scope, any type of virtualization technology, including “container” based virtualization technology (such as, but not limited to, Kubernetes). In examples, the at least one VNF is implemented using at least one virtual entity (such as Kubernetes Pods, virtual machine(s), container(s), etc.) referred to herein as a vDAS container. In examples, each vDAS container is implemented in a Pod in Kubernetes virtualization environment. In other examples, container or other computing entities are used instead of Kubernetes Pods.

When the DAS 100 of any of FIGS. 1A-1D is virtualized as a vDAS 100, it is especially well-suited for use in deployments in which base stations from multiple wireless service operators share the same vDAS 100 (including, for example, neutral host deployments or deployments where one wireless service operator owns the vDAS 100 and provides other wireless service operators with access to its vDAS 100). The vDAS 100 described here is especially well-suited for use in such deployments because additional virtualized components be easily instantiated in order to support additional wireless service operators. This is the case even if an additional physical server 126 is needed in order to instantiate additional virtualized components because a physical server 126 is either already available in such deployments or can be easily added at a low cost (for example, because of the COTS nature of such hardware).

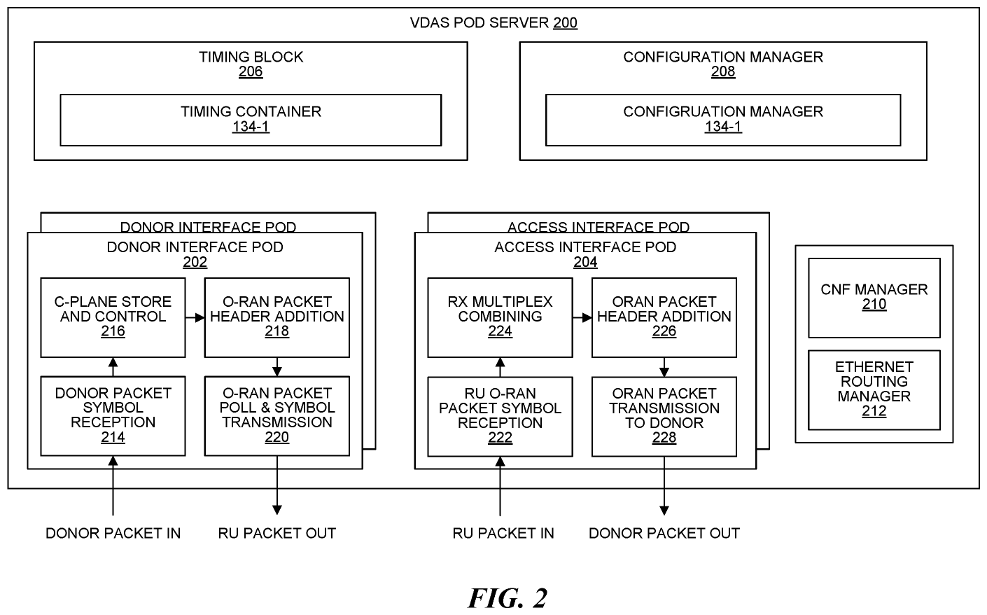

FIG. 2 is an example block diagram of a vDAS Pod server 200. While the vDAS Pod server 200 is described in FIG. 2, it is understood that containers or other types of computing entities (other than Pods) can be used in implementations. vDAS Pod server 200 includes at least one donor interface Pod 202, at least one access interface Pod 204, a timing block 206, a configuration manager 208, a CNF manager 210, and an Ethernet routing manager 212. In examples, donor interface Pod 202 and access interface Pod 204 are repeated multiple times based upon the traffic desired and any spikes in the traffic such that multiple instances of these Pods are running inside the vDAS Pod server 200. In examples, each donor interface Pod 202 includes a donor packet symbol reception entity 214, a C-plane store and control entity 216, an O-RAN packet header addition entity 218, and an O-RAN packet poll & symbol transmission entity 220. In examples, each donor interface Pod 202 is for managing the CU plane and the uplink combining for a single simulcast zone. In examples, the timing block and platform block do not scale, but the donor interface Pod 202 and access interface Pod 204 can be scaled with multiple instances of each.

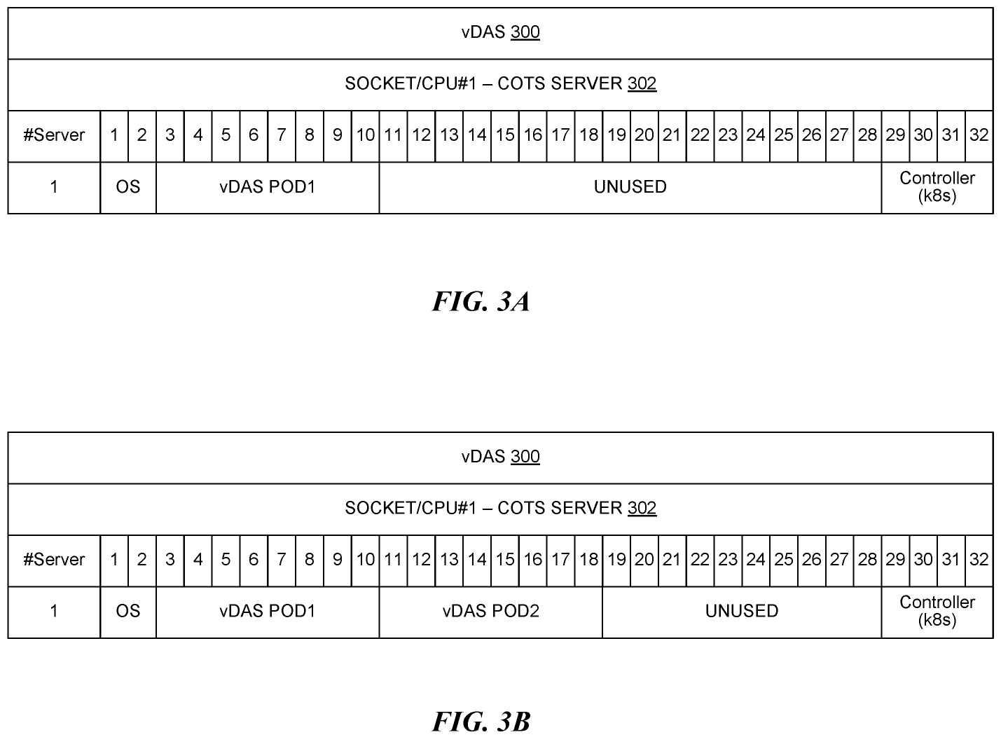

FIGS. 3A-3B are example block diagrams showing a vDAS 300 implementing scaling using a monolithic service architecture. FIG. 3A shows a vDAS 300 implemented using a server 402 having 32 cores. In examples, a vDAS POD1 is implemented on cores 2-10 (eight cores) as a monolithic network function (NF) with a single entity without modularization. In examples, an OS is implemented on cores 1-2 and a controller (k8s) is implemented on cores 29-32. In examples, cores 11-28 are unused. In examples, the vDAS POD1 implements the monolithic distributed antenna system (DAS) network function (NF). In examples, the DAS NF has one DAS service to implement with a number of RUs (such as 50 RUs or 100 RUs). In examples implementing scaling using a monolithic service architecture, when the DAS NF is going to be scaled to handle new traffic, the DAS service implemented by vDAS POD1 (service instance 1) will scale out to include a new vDAS POD2 (service instance 2) when there is a requirement to add additional workloads for increasing traffic. FIG. 3B shows the vDAS 300 after a scaling out using POD autoscaling using a monolithic service architecture with a replication factor of 2, resulting in a vDAS POD2 being implemented on cores 11-18. In examples, vDAS POD2 is for handling additional carrier traffic. In examples, scaling using a monolithic service architecture means you are creating a replication factor of the existing POD1 to create a new POD2 to handle the increase in traffic. In examples, POD2 is a copy/replica of the existing POD1 and is instantiated to handle the new traffic. In examples, the DAS NF can be scaled with more than a first vDAS POD1 and a second vDAS POD2. In examples, scaling out means the number of Pods is increased to handle an increase in traffic, while scaling in means that if network traffic lowers, you can go into maintenance mode and delete a POD. In examples, resources are always optimized and the unused pace can be used for some other applications to run. In examples, each monolithic NF has only one service and one service instance and the DAS cannot be scaled at the service level. In examples, an operator gives a set of requirements and the scaling using a monolithic service architecture occurs to meet these requirements. For example, an operator may want 100 RUs, but the DAS network function can only handle up to 30 RUs. In this example, the moment the traffic spikes, an additional instance of the vDAS POD (vDAS POD2) is instantiated for RUs number 30-60 to be added. Scaling using a monolithic service architecture by replicating vDAS Pods requires NF level scaling, which changes the network topology as new nodes get added. In examples implementing scaling using a monolithic service architecture through NF level scaling, the network topology of DU to DAS to RU will change whenever a new node of a DAS is added. NF level scaling requires an orchestrator to be involved.

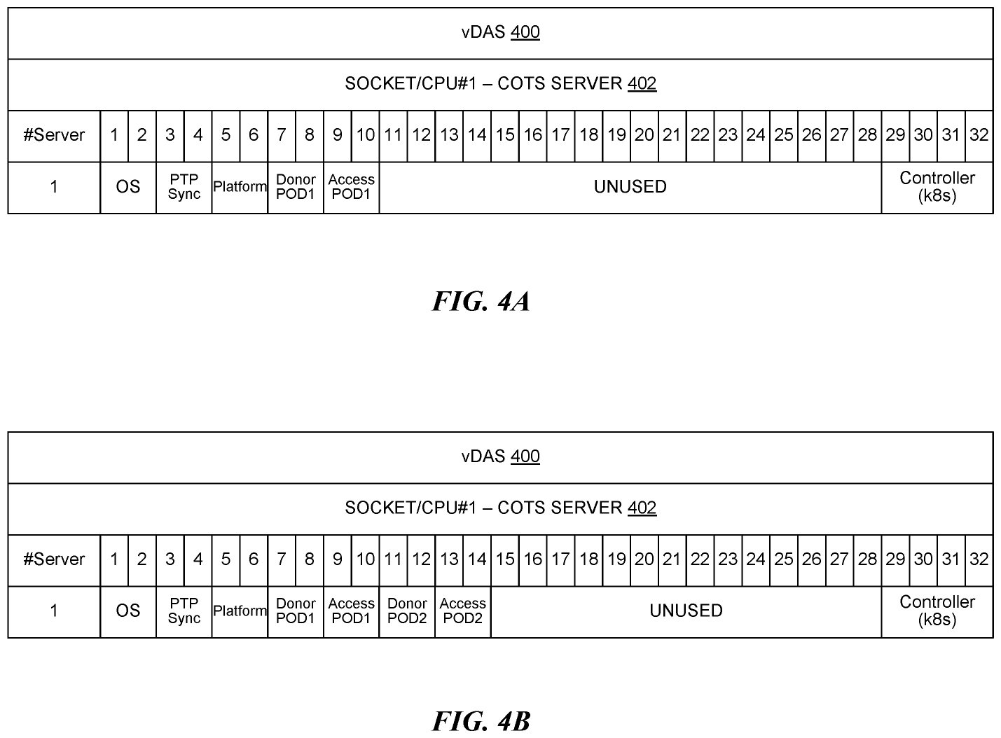

FIGS. 4A-4B are example block diagrams showing a vDAS 400 implementing scaling using multiple micro-service architecture. FIG. 4A shows a vDAS 400 implemented using a server 402 having 32 cores. In examples implementing scaling using multiple micro-service architecture, the DAS NF is split into multiple micro-services running as different internal Pods: a PTP sync POD is implemented on cores 3-4, a platform POD is implemented on cores 5-6, a donor POD1 is implemented on cores 7-8, and an access POD1 is implemented on cores 9-10. In examples, an OS is implemented on cores 1-2 and a controller (k8s) is implemented on cores 29-32. In examples, cores 11-28 are unused. In examples, the donor POD1 corresponds to a service that is coming on the northbound interface (such as an O-RAN source, an RF source, a CPRI source, etc.) and terminates in the donor POD1. In examples, the donor POD1 converts packets and sends them to the southbound interface. In examples, the access POD1 performs uplink combining on traffic that comes from southbound RUs and provide a combined signal to the northbound interface. In examples implementing scaling using multiple micro-service architecture, scaling occurs on the donor POD and access Pods resulting in multiple donor Pods and multiple access Pods, while the PTP sync and platform POD always run single Pods. In examples implementing scaling using multiple micro-service architecture when there is new traffic to be handled for the CU-Plane traffic on the fronthaul side, only the donor POD and the access POD will be scaled. In examples, the donor Pods and access Pods scale linearly with each other. FIG. 4B shows the vDAS 400 after a scaling up using POD autoscaling, where donor POD1 is scaled to donor POD2 (using two additional cores at cores 11-12) and access POD1 is scaled to access POD2 (using two additional cores at cores 13-14) to handle additional traffic. In examples, since each NF has multiple micro-services, the DAS can be scaled at the service level, which does not change the network topology as new services get added. In examples, the entire DAS NF is connected to the DU on the northbound interface and the RUs on the southbound interface such that increasing multiple Pods inside an existing network function does not require change the network topology.

While the scaling using a monolithic service architecture shown in FIGS. 3A-3B requires a full copy of the entire vDAS POD be created, the scaling of FIGS. 4A-4B is optimized so that you only replicate the instances of the Pods that are required for scaling (the donor POD and the access POD). Accordingly, for scaling using a monolithic service architecture where scaling requires a change in network topology, the association between DU to DAS to RU will be updated. In contrast, for scaling using micro-services architecture where scaling does not require any change in the network topology, the association between DU to DAS to RU does not need to be updated because in the same network function you are increasing the Pods for donor and access without changing the PTP POD or the platform POD. In examples, scaling using a monolithic service architecture may be preferable when a higher footprint server is being used for a larger deployment and resource efficiency can be maximized requiring the complexity of scaling using micro-services architecture. In examples, scaling using a monolithic service architecture is easier to implement and less complex than scaling using micro-services architecture. Based on what type of compute node is running on the server and how much traffic is desired, scaling using a monolithic service architecture or scaling using micro-services architecture can be selected. In examples, the hardware and high level software can implement either scaling using a monolithic service architecture or scaling using micro-services architecture and one or the other can be selected for the particular deployment. In examples, scaling using a monolithic service architecture will require a change in network topology, which increases complexity when it is necessary to rehome an RU. In examples, scaling using micro-services architecture does not require a change in network topology as the network connectivity will be the same toward the DU and towards the RU. While this makes scaling using micro-services architecture easier in that it does not require a topology change, scaling using micro-services architecture is more complicated in that it requires modularization of the network function in such a way that the ground level Pods only have to be increased while the other network functions do not have to be increased.

In examples, the network function is setup using either a scaling using a monolithic service architecture model or a scaling using micro-services architecture model. In examples, it would be complex to switch from one scaling model to the other after initial setup as switching from a scaling using a monolithic service architecture model to a scaling using micro-services architecture model would require switching between a monolithic network function and micro-service based network function. In examples, the same hardware is used for either the scaling using a monolithic service architecture model or the scaling using micro-services architecture model, so it is possible to switch between one to the other, though potentially complex, particularly in going form a scaling using a monolithic service architecture model to a scaling using micro-services architecture mode. In examples, higher resource efficiency is achieved with scaling using micro-services architecture because scaling using a monolithic service architecture creates a copy of the existing network function, including the entire a copy of elements that are not copied with scaling using micro-services architecture.

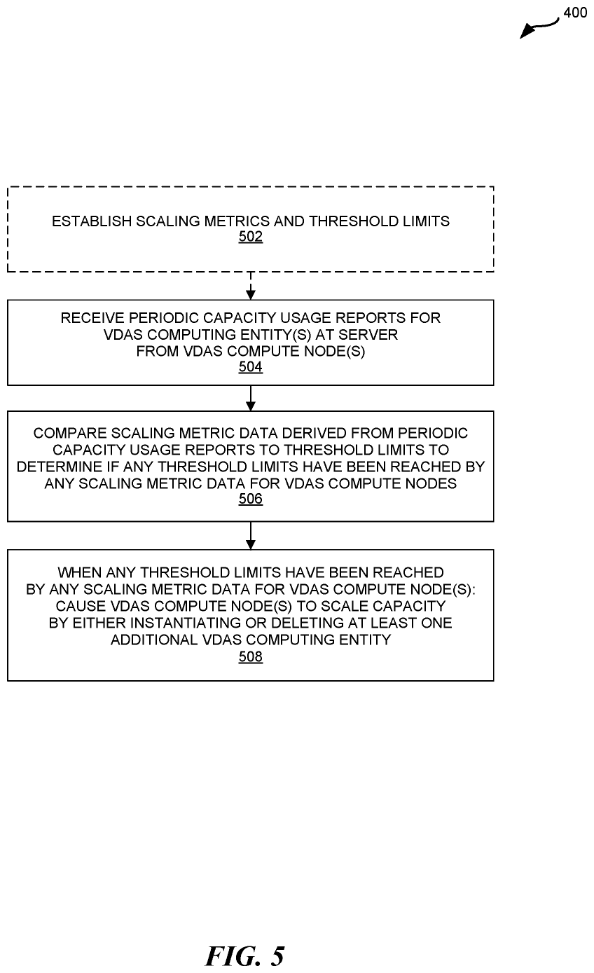

FIG. 5 is a flow diagram illustrating a method 500 implemented in a virtualized distributed antenna system (vDAS) including at least one server and at least one vDAS compute node having a plurality of cores and implementing at least one virtual network function (NF) for at least one radio unit (RU) using at least one vDAS container running on a first subset of the plurality of cores. Method 500 begins at block 502 with optionally establishing scaling metrics and threshold limits. In examples, scaling metrics include a number of cells for the vDAS container (such as implemented by Pod(s)), a number of RUs per vDAS (such as implemented by Pod(s)), throughput per vDAS (such as implemented by Pod(s)), and processing loads of central processing unit (CPU) cores per vDAS (such as implemented by Pod(s)). In examples, the scaling metrics may relate to cell based overloading or CPU based overloading. In examples relating to cell based overloading for a vDAS, the cell based overloading is capacity based. In examples, a DAS Pod spanning a certain number of cores (such as 8 cores) will be capable of handling a certain number of cells per DAS network function (such as 10 cells per DAS network function). In examples, a maximum number of RUs (such as 50 RUs) can be handled by a DAS Pod. In examples, a maximum throughput (such as 600 Gbps) is available per DAS Pod. In examples, threshold limits can be set through a Service Management and Orchestration (SMO) (such as CommScope's Database Management Service (DMS)). In examples, the CPU for the DAS might have a limit of 8 cores per DAS network function. In examples, the threshold limits are used to provision the system.

In examples, threshold limits include upper limits, such as: a maximum number of cells for the vDAS container (such as implemented by Pod(s)); a maximum number of radio units (RUs) for the vDAS container (such as implemented by Pod(s)); a maximum throughput for the vDAS container (such as implemented by Pod(s)); and a maximum processing load of cores for the vDAS container (such as implemented by Pod(s)). In examples, threshold limits include lower limits, such as: a first minimum number of cells for the vDAS container (such as implemented by Pod(s)); a second minimum number of radio units (RUs) for the vDAS container; a minimum throughput for the vDAS container (such as implemented by Pod(s)); and a minimum processing load of cores for the vDAS container (such as implemented by Pod(s)). In examples, the network function (NF) descriptors send scaling metrics (Network Service Descriptors (NSD) threshold) to the Network Service Orchestrator (NSO). In examples, the NSO will have all the policies for the scaling metrics. In examples, when the vDAS container (such as implemented by Pod) is running, it periodically sends the report to a metrics server, the metrics server then passes this onto the API server as metrics API (KPIs), and the API server then sends it (KPIs) to the POD autoscaler.

Method 500 proceeds to block 504 with receiving periodic capacity usage reports for vDAS container (such as implemented by a Pod) at at least one server from at least one vDAS compute node. In examples, the periodic capacity usage reports for vDAS container (such as implemented by a Pod) are received at a metrics server, then processed and/or forwarded to an API server, then further processed and/or forwarded to a POD autoscaler. In examples, the metrics server, the API server, and/or the POD autoscaler are implemented using at least one physical server (such as server 126 described above).

Method 500 proceeds to block 506 with comparing scaling metric data derived from the periodic capacity usage reports to threshold limits to determine if any threshold limits have been reached by any scaling metric data for the at least one vDAS compute node. In examples, the scaling metric data is derived from the periodic capacity usage reports at any combination of the metrics server, the API server, and/or the POD autoscaler.

Method 500 proceeds to block 508 with when any of the threshold limits have been reached by any of the scaling metric data for the at least one vDAS compute node: causing the at least one vDAS compute node to scale capacity by either instantiating or deleting at least one additional vDAS container on a second subset of the plurality of cores of the at least one vDAS compute node. In examples where at least one additional vDAS container is to be deleted, the RUs, cells, and traffic handled by the at least one additional vDAS container to be deleted are transferred to at least one other vDAS container that is not being deleted. In examples, deleting the at least one vDAS container only occurs when there is enough capacity left on the at least one other vDAS container that is not being deleted to accept this transition of load from the at least one additional vDAS container to be deleted. In examples, any combination of the metrics server, the API server, and/or the POD autoscaler causes the at least one vDAS computing node to scale capacity. In examples where the threshold limits are upper limits, if any of the upper limits have been exceeded by any of the scaling metric data, then the system can go into an overload control mode. Overload control mitigates a bottleneck in the network (where the network cannot handle new traffic requests) by going into maintenance mode, which disables handling of any new/additional network requests coming from the operator. New traffic can then again be handled once the traffic gets below the threshold. Overload can occur when many devices are trying to access the network simultaneously (such as in a stadium, large building, etc.) which can result in throughput exceeding the available bandwidth, resulting in buffering or low service quality.

While an overload control mode could cause connection rejection for new traffic and puts the system into maintenance mode until the traffic level goes below the threshold again, examples of the system can instantiate a new vDAS container (such as implemented by a Pod) for the DU and RU to handle the increased traffic (instead of stopping handling new traffic because of being overloaded). Said another way, instead of stopping the requests, a new vDAS container (such as implemented by a Pod) is instantiated to handle the traffic spike. In examples, if none of the threshold limits have been reached, then the new traffic can be provided access to the DAS. In examples, when an upper limit is met, the system is scaled out or scaled up as a new vDAS container (such as implemented by a Pod) is created. In examples, when a lower limit is met, the system is scaled in or scaled down as a vDAS container(s) (such as implemented by a Pod) is deleted.

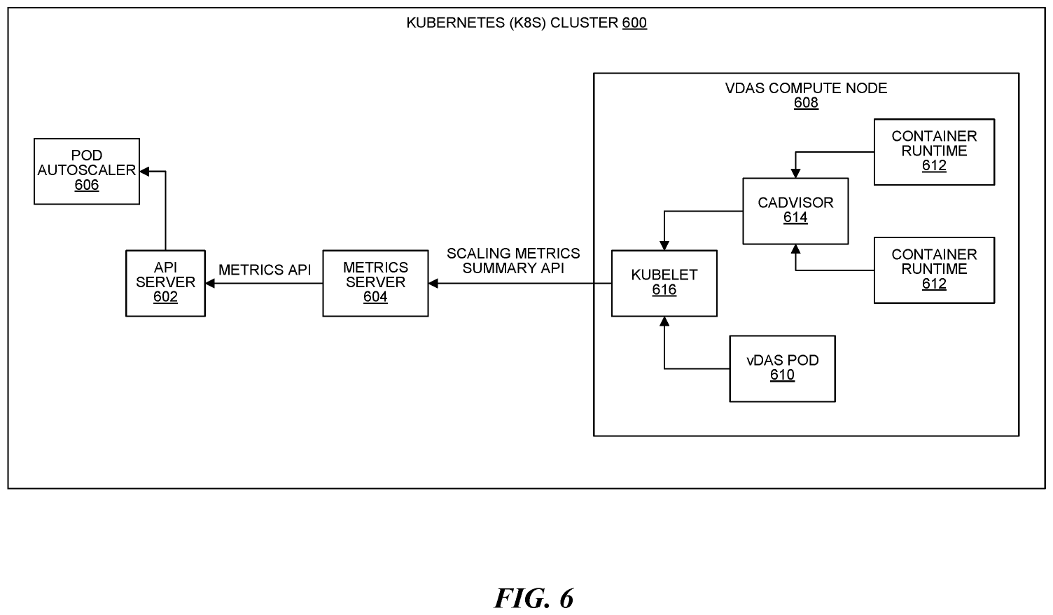

FIG. 6 is an example block diagram showing a Kubernetes (k8s) Cluster 600 for a system implementing autoscaling in hyperscaling platforms using Pods in Kubernetes. In examples, the existing Kubernetes design methodology can be implemented into the system. In examples, the Kubernetes (k8s) Cluster 600 includes the orchestration server running in a centralized location having three PODS: (1) API server 602; (2) metrics server 604; and (3) POD Autoscaler node 606 (using either micro-services architecture or a monolithic service architecture); and a vDAS Compute Node 608 is running at a remote location. In examples, the vDAS Compute Node 608 includes a vDAS POD 610, container runtime engines 612, cAdvisor service 614, and kubelet service 616. In examples, the API server 602 is a cluster addon component that collects and aggregates resource metrics pulled from each kubelet service 616. In examples, the kubelet service 616 is a node agent for managing container resources. In examples, resource metrics are accessible using the metrics/resource and stats kubelet API endpoints. In examples, scaling metrics summary API is an API provided by the kubelet service 616 to the metrics server for discovering and retrieving per-node summarized stats available through the stats endpoint. In examples, the metrics API is sent from the metrics server 604 to the API server 602. In examples, the metrics API is a Kubernetes API supporting access to CPU and memory used for workload autoscaling.

Periodically, the remote server (including vDAS Compute Node 608) in the remote location will send the periodic reports of the traffic being handled and the summary data will get sent up to the centralized server (including metrics server 604) running in a centralized location. More specifically, in examples, when the vDAS POD 610 is running, usage and traffic data of the vDAS POD is sent to the kubelet service 616. The kubelet service 616 will take the aggregated data coming from the DAS and periodically send it to the metrics server 604. The metrics server 604 will keep collecting the periodic scaling metrics data coming from the vDAS Compute Node 608. Once the metrics server 604 has collected the scaling metric data, it will pass it onto the API server 602. Then the API server 602 sends it to the POD autoscaler node 606, which determines whether the scaling thresholds are met or not. If the scaling thresholds are not met, the POD autoscaler node 606 will not do anything. If the scaling thresholds are met, the POD autoscaler node 606 will perform the autoscaling based on either a monolithic service architecture or a micro-services architecture. If the threshold level is crossed, then the POD autoscaler node 606 will either do a scale up or a scale out.

In examples, an SMO tracks network topology changes and the individual content details for the DAS POD. In examples, the content details include: (1) the O-RU configuration; and (2) the Event Notification from the O1/O2 interfaces. In examples, the O1 interface includes anything on the management side FFAS (Form, Function, Account, and Security) while the O2 interface is for the cloud information, including the IP details, the POD level details, or the orchestration details. In examples, each vDAS POD has a DAS identifier (DAS ID). In examples, information about how the vDAS POD connects to the DU is included. In examples, the IP address for network connectivity to the DAS and the RU is included. In examples, the following are also included: the network function ID (nfId) that identifies a DAS network function (NF); network function label (nfLabel) (relating to multilevel ports), nfType, and nfState (which state it is on). In examples, the SMO tracks these details for a network topology. In examples, the SMO tracks the network topology as the entire connectivity between a DAS connecting to a DU on the northbound interface and the DAS connecting to the RU on the southbound interface. In examples, the SMO retrieves the RU Configuration through NETCONF for a newly instantiated DAS POD (including Inventory and Config Details). In examples, the SMO receives Event Notification from O1/O2 Interfaces including the Attribute Details of DAS ID, DU ID, IP Address, nfId, nfLabel, nfType, NfState details. In examples, the SMO pushes the DAS Configuration over O1 NetConf Interface. DAS Configuration would include attributes: (1) gNBDU Function (for 5G); (2) NRCellDU (for 5G); (3) NRSectorCarrier (for 5G); (4) RU Related Info; and (5) Scaling Metrics and RU Rehoming Flag. In examples, the SMO will create a table with one table entry for every new DAS entity and it has to have connectivity to the northbound and southbound interfaces. In examples, whenever a new DAS POD has to be instantiated for scaling using a monolithic service architecture, a new entry is added into the table so it has proper connectivity on the northbound and the southbound interfaces so that traffic can flow.

In examples implementing network function (NF) scaling, it is necessary to determine in the southbound direction whether the RUs which are connected to the existing vDAS entity need to be rehomed to the new vDAS entity. In examples, rehoming occurs when you need to add new RUs to an existing DAS POD. In examples, rehoming entails deleting the connection to the existing POD and making a new connection to the new DAS POD which has been instantiated. In examples, the SMO provides the IP Address of DU and RU to the DAS. In examples where RU rehoming is not necessary, the existing DAS will be connected to the RU, overload control will be implemented to reject new DAS access requests from DUs, DAS connection release will be provided to the existing DUs, and a new DAS POD is instantiated to handle new DAS to new RU associations. In examples where RU rehoming is necessary, the existing DAS will relinquish connection to the RU, and a new DAS POD will be instantiated to handle new DAS to old RU associations (there will be a service impact with this association).

In examples, rehoming may be necessary anytime any of the threshold limits are exceeded and adding a new DAS POD would require an update to the topology, though rehoming may not be necessary if new RUs are being added to a deployment with a new DAS POD and you do not need to switch RUs from one to another. In examples, rehoming is only necessary for scaling using a monolithic service architecture when an additional copy of the network function is being created. In examples, the topology for some of the RUs may need to be switched from being associated from the old DAS POD to the new DAS POD because the new DAS POD needs to be connected to a some of the RUs from the previous DAS POD. In examples, a topology change is present when the IP address for the RU(s) switching from one DAS POD to another DAS POD will change. In examples, the topology changes when there is a connectivity change required for northbound and southbound connections such that a new entry needs to be added or updated in to the SMO. In this case, the RU related info may change for the new DAS POD. In examples, rehoming is not required for scaling using micro-services architecture. In POD scaling using micro-services architecture, only the instance of donor POD or access interface POD will be scaled. In this case the connectivity for the DU and the RU will not change, only the granular level Pods will be sized up and down.

In examples of rehoming, the RUs connected to the previous DAS POD are disconnected, a new DAS POD is created, and the disconnected RUs are connected back to the new DAS POD so that the association is established for the new DAS to RU connectivity. In examples, the SMO supports a topology change through dynamic mapping of DU to DAS to RU table entries. In examples, whenever a new POD has been scaled, this connectivity between DU to DAS to RU has to be updated within the SMO for mapping the change. In examples, the SMO deletes the entry of the old DAS ID and locks the corresponding RU before the RU can connect to the new DAS. In examples, the NSO will delete the DAS POD (NF) as it was the old NF connectivity to the RU. In examples, A new DAS POD is spawned by the k8s Orchestrator. In examples, after the new DAS POD is spawned, the SMO attempts to connect to the RUs that have been deleted from the old DAS POD and unlocks the corresponding RU which is locked. In examples, the NSO sends notification (RuStateChange) to CMS and CMS notifies that the new DAS POD has been instantiated based on the new RU to DAS mapping. In examples, SMO selects the unlocked RU to the new DAS POD through platform configuration.

In examples implementing rehoming, the SMO will have an entry between DU to DAS to RU corresponding to the traffic. In examples when the threshold level has been exceeded, the SMO relinquishes the RUs that were connected to the old POD but are going to be connected to the new POD by: (1) removing RUs connected to the old POD, which need to be respawned; (2) creating a new DAS POD from the orchestrator; (3) after creating the new DAS POD, whatever the old RUs are being taken from the old DAS POD to the new one will be reconnected to the new DAS POD and the RU connectivity to the DAS will be established and only then is the RU unlocked to continue handling the traffic.

The methods disclosed herein comprise one or more steps or actions for achieving the described method. Unless a specific order of steps or actions is required for proper operation of the method that is being described, the order and/or use of specific steps and/or actions may be modified without departing from the scope of the claims.

While detailed descriptions of one or more configurations of the disclosure have been given above, various alternatives, modifications, and equivalents will be apparent to those skilled in the art without varying from the spirit of the disclosure. For example, while the configurations described above refer to particular features, functions, procedures, components, elements, and/or structures, the scope of this disclosure also includes configurations having different combinations of features, functions, procedures, components, elements, and/or structures, and configurations that do not include all of the described features, functions, procedures, components, elements, and/or structures. Accordingly, the scope of the present disclosure is intended to embrace all such alternatives, modifications, and variations as fall within the scope of the claims, together with all equivalents thereof. Therefore, the above description should not be taken as limiting.

### Examples

Example 1 includes a computing system having a vDAS compute node implementing at least one virtual network function (NF) in a virtualized distributed antenna system (vDAS) having a plurality of radio units (RUS), the computing system comprising: at least one server having at least one processor; at least one vDAS compute node having at least one central processing unit with a plurality of cores, wherein the at least one vDAS compute node includes at least one vDAS container running on a first subset of the plurality of cores; wherein the at least one server is configured to: receive periodic capacity usage reports from the at least one vDAS compute node; compare scaling metric data derived from the periodic capacity usage reports to threshold limits to determine if any of the threshold limits have been reached by any of the scaling metric data for the at least one vDAS compute node; when any of the threshold limits have been reached by any of the scaling metric data for the at least one vDAS compute node: cause the at least one vDAS compute node to scale capacity by either instantiating or deleting at least one additional vDAS container on a second subset of the plurality of cores of the at least one vDAS compute node.
Example 2 includes the computing system of Example 1, wherein the threshold limits include upper limits that, when exceeded, cause the at least one vDAS compute node to increase the capacity of the at least one vDAS compute node by instantiating the at least one additional vDAS container on the second subset of the plurality of cores of the at least one vDAS compute node.
Example 3 includes the computing system of Example 2, wherein the upper limits include: a first maximum number of cells for the at least one vDAS container; a second maximum number of radio units (RUs) for the at least one vDAS container; a maximum throughput for the at least one vDAS container; and a maximum processing load of cores for the at least one vDAS container.
Example 4 includes the computing system of any of Examples 1-3, wherein the threshold limits include lower limits that, when not met, cause the at least one vDAS compute node to decrease the capacity of the at least one vDAS compute node by deleting the at least one additional vDAS container on the second subset of the plurality of cores of the at least one vDAS compute node.
Example 5 includes the computing system of Example 4, wherein the lower limits include: a first minimum number of cells for the at least one vDAS container; a second minimum number of radio units (RUs) for the at least one vDAS container; a minimum throughput for the at least one vDAS container; and a minimum processing load of cores for the at least one vDAS container.
Example 6 includes the computing system of any of Examples 1-5, wherein the at least one server is configured to cause the at least one vDAS compute node to scale the capacity of the at least one vDAS compute node through at least one of scaling using a monolithic service architecture or scaling using micro-services architecture.
Example 7 includes the computing system of any of Examples 1-6, wherein the at least one server is configured to cause the at least one vDAS compute node to increase the capacity of the at least one vDAS compute node by instantiating the at least one additional vDAS container on the at least one vDAS compute node at least in part by being configured to: replicate the at least one vDAS compute node to create at least a second vDAS container.
Example 8 includes the computing system of any of Examples 1-7, wherein the at least one vDAS compute node includes a first donor container and a first access container; and wherein the at least one server is configured to cause the at least one vDAS compute node to increase the capacity of the at least one vDAS compute node by instantiating the at least one additional vDAS container on the at least one vDAS compute node at least in part by being configured to: create an additional donor container and access container.
Example 9 includes a method implemented in a virtualized distributed antenna system (vDAS) including at least one server and at least one vDAS compute node having a plurality of cores and implementing at least one virtual network function (NF) for at least one radio unit (RU) using at least one vDAS container running on a first subset of the plurality of cores, the method comprising: receiving periodic capacity usage reports for the at least one vDAS container at the at least one server from the at least one vDAS compute node; comparing scaling metric data derived from the periodic capacity usage reports to threshold limits to determine if any of the threshold limits have been reached by any of the scaling metric data for the at least one vDAS compute node; when any of the threshold limits have been reached by any of the scaling metric data for the at least one vDAS compute node: causing the at least one vDAS compute node to scale capacity of the at least one vDAS compute node by either instantiating or deleting at least one additional vDAS container on a second subset of the plurality of cores of the at least one vDAS compute node.
Example 10 includes the method of Example 9, further comprising: wherein the threshold limits include upper limits; and causing the at least one vDAS compute node to increase the capacity of the at least one vDAS compute node by instantiating the at least one additional vDAS container on the second subset of the plurality of cores of the at least one vDAS compute node.
Example 11 includes the method of Example 10, wherein the upper limits include: a first maximum number of cells for the at least one vDAS container; a second maximum number of radio units (RUs) for the at least one vDAS container; a maximum throughput for the at least one vDAS container; and a maximum processing load of cores for the at least one vDAS container.
Example 12 includes the method of any of Examples 9-11, further comprising: wherein the threshold limits include lower limits; and causing the at least one vDAS compute node to decrease the capacity of the at least one vDAS compute node by deleting the at least one additional vDAS container on the second subset of the plurality of cores of the at least one vDAS compute node.
Example 13 includes the method of Example 12, wherein the lower limits include: a first minimum number of cells for the at least one vDAS container; a second minimum number of radio units (RUs) for the at least one vDAS container; a minimum throughput for the at least one vDAS container; and a minimum processing load of cores for the at least one vDAS container.
Example 14 includes the method of any of Examples 9-13, wherein causing the at least one vDAS compute node to scale the capacity of the at least one vDAS compute node occurs through at least one of scaling using a monolithic service architecture or scaling using micro-services architecture.
Example 15 includes the method of any of Examples 9-14, wherein causing the at least one vDAS compute node to increase the capacity of the at least one vDAS compute node by instantiating the at least one additional vDAS container on the second subset of the plurality of cores of the at least one vDAS compute node includes: replicating the at least one vDAS compute node.
Example 16 includes the method of any of Examples 9-15, wherein the at least one vDAS compute node includes a first donor container and a first access container; and wherein causing the at least one vDAS compute node to increase the capacity of the at least one vDAS compute node by instantiating the at least one additional vDAS container on the second subset of the plurality of cores of the at least one vDAS compute node includes: creating an additional donor container and access container.
Example 17 includes a non-transitory processor-readable medium on which program instructions, configured to be executed by at least one processor, are embodied, wherein when executed by the at least one processor, the program instructions cause the at least one processor to: receive, at at least one server from at least one vDAS compute node, periodic capacity usage reports for at least one virtualized distributed antenna system (vDAS) including at least one vDAS container operating on a first subset of a plurality of cores of the at least one vDAS compute node; compare scaling metric data derived from the periodic capacity usage reports to threshold limits to determine if any of the threshold limits have been reached by any of the scaling metric data for the at least one vDAS compute node; when any of the threshold limits have been reached by any of the scaling metric data for the at least one vDAS compute node: causing the at least one vDAS compute node to scale capacity of the at least one vDAS compute node by either instantiating or deleting at least one additional vDAS container on a second subset of the plurality of cores of the at least one vDAS compute node.
Example 18 includes the non-transitory processor-readable medium of Example 17, wherein: the threshold limits include upper limits that, when exceeded, cause the at least one vDAS compute node to increase the capacity of the at least one vDAS compute node by instantiating the at least one additional vDAS container on the second subset of the plurality of cores of the at least one vDAS compute node; and the upper limits include: a first maximum number of cells for the at least one vDAS container; a second maximum number of radio units (RUs) for the at least one vDAS container; a maximum throughput for the at least one vDAS container; and a maximum processing load of cores for the at least one vDAS container.
Example 19 includes the non-transitory processor-readable medium of any of Examples 17-18, wherein: the threshold limits include lower limits that, when not met, cause the at least one vDAS compute node to decrease the capacity of the at least one vDAS compute node by deleting the at least one additional vDAS container on the second subset of the plurality of cores of the at least one vDAS compute node; and the lower limits include: a first minimum number of cells for the at least one vDAS container; a second minimum number of radio units (RUs) for the at least one vDAS container; a minimum throughput for the at least one vDAS container; and a minimum processing load of cores for the at least one vDAS container.
Example 20 includes the non-transitory processor-readable medium of any of Examples 17-19, wherein causing the at least one vDAS compute node to scale the capacity of the at least one vDAS compute node occurs through at least one of scaling using a monolithic service architecture or scaling using micro-services architecture.

What is claimed is:

1. A computing system having a vDAS compute node implementing at least one virtual network function (NF) in a virtualized distributed antenna system (vDAS) having a plurality of radio units (RUS), the computing system comprising:
at least one server having at least one processor;
at least one vDAS compute node having at least one central processing unit with a plurality of cores, wherein the at least one vDAS compute node includes at least one vDAS container running on a first subset of the plurality of cores;
wherein the at least one server is configured to:
receive periodic capacity usage reports from the at least one vDAS compute node;
compare scaling metric data derived from the periodic capacity usage reports to threshold limits to determine if any of the threshold limits have been reached by any of the scaling metric data for the at least one vDAS compute node;
when any of the threshold limits have been reached by any of the scaling metric data for the at least one vDAS compute node:
cause the at least one vDAS compute node to scale capacity by either instantiating or deleting at least one additional vDAS container on a second subset of the plurality of cores of the at least one vDAS compute node.

2. The computing system of claim 1, wherein the threshold limits include upper limits that, when exceeded, cause the at least one vDAS compute node to increase the capacity of the at least one vDAS compute node by instantiating the at least one additional vDAS container on the second subset of the plurality of cores of the at least one vDAS compute node.

3. The computing system of claim 2, wherein the upper limits include:
a first maximum number of cells for the at least one vDAS container;
a second maximum number of radio units (RUs) for the at least one vDAS container;
a maximum throughput for the at least one vDAS container; and
a maximum processing load of cores for the at least one vDAS container.

4. The computing system of claim 1, wherein the threshold limits include lower limits that, when not met, cause the at least one vDAS compute node to decrease the capacity of the at least one vDAS compute node by deleting the at least one additional vDAS container on the second subset of the plurality of cores of the at least one vDAS compute node.

5. The computing system of claim 4, wherein the lower limits include:
a first minimum number of cells for the at least one vDAS container;
a second minimum number of radio units (RUs) for the at least one vDAS container;
a minimum throughput for the at least one vDAS container; and
a minimum processing load of cores for the at least one vDAS container.

6. The computing system of claim 1, wherein the at least one server is configured to cause the at least one vDAS compute node to scale the capacity of the at least one vDAS compute node through at least one of scaling using a monolithic service architecture or scaling using micro-services architecture.

7. The computing system of claim 1, wherein the at least one server is configured to cause the at least one vDAS compute node to increase the capacity of the at least one vDAS compute node by instantiating the at least one additional vDAS container on the at least one vDAS compute node at least in part by being configured to:
replicate the at least one vDAS compute node to create at least a second vDAS container.

8. The computing system of claim 1, wherein the at least one vDAS compute node includes a first donor container and a first access container; and
wherein the at least one server is configured to cause the at least one vDAS compute node to increase the capacity of the at least one vDAS compute node by instantiating the at least one additional vDAS container on the at least one vDAS compute node at least in part by being configured to:
create an additional donor container and access container.

9. A method implemented in a virtualized distributed antenna system (vDAS) including at least one server and at least one vDAS compute node having a plurality of cores and implementing at least one virtual network function (NF) for at least one radio unit (RU) using at least one vDAS container running on a first subset of the plurality of cores, the method comprising:
receiving periodic capacity usage reports for the at least one vDAS container at the at least one server from the at least one vDAS compute node;
comparing scaling metric data derived from the periodic capacity usage reports to threshold limits to determine if any of the threshold limits have been reached by any of the scaling metric data for the at least one vDAS compute node;
when any of the threshold limits have been reached by any of the scaling metric data for the at least one vDAS compute node:
causing the at least one vDAS compute node to scale capacity of the at least one vDAS compute node by either instantiating or deleting at least one additional vDAS container on a second subset of the plurality of cores of the at least one vDAS compute node.

10. The method of claim 9, further comprising:
wherein the threshold limits include upper limits; and
causing the at least one vDAS compute node to increase the capacity of the at least one vDAS compute node by instantiating the at least one additional vDAS container on the second subset of the plurality of cores of the at least one vDAS compute node.

11. The method of claim 10, wherein the upper limits include:
a first maximum number of cells for the at least one vDAS container;
a second maximum number of radio units (RUs) for the at least one vDAS container;
a maximum throughput for the at least one vDAS container; and
a maximum processing load of cores for the at least one vDAS container.

12. The method of claim 9, further comprising:
wherein the threshold limits include lower limits; and
causing the at least one vDAS compute node to decrease the capacity of the at least one vDAS compute node by deleting the at least one additional vDAS container on the second subset of the plurality of cores of the at least one vDAS compute node.

13. The method of claim 12, wherein the lower limits include:
a first minimum number of cells for the at least one vDAS container;
a second minimum number of radio units (RUs) for the at least one vDAS container;
a minimum throughput for the at least one vDAS container; and
a minimum processing load of cores for the at least one vDAS container.

14. The method of claim 9, wherein causing the at least one vDAS compute node to scale the capacity of the at least one vDAS compute node occurs through at least one of scaling using a monolithic service architecture or scaling using micro-services architecture.

15. The method of claim 9, wherein causing the at least one vDAS compute node to increase the capacity of the at least one vDAS compute node by instantiating the at least one additional vDAS container on the second subset of the plurality of cores of the at least one vDAS compute node includes:
replicating the at least one vDAS compute node.

16. The method of claim 9, wherein the at least one vDAS compute node includes a first donor container and a first access container; and
wherein causing the at least one vDAS compute node to increase the capacity of the at least one vDAS compute node by instantiating the at least one additional vDAS container on the second subset of the plurality of cores of the at least one vDAS compute node includes:
creating an additional donor container and access container.

17. A non-transitory processor-readable medium on which program instructions, configured to be executed by at least one processor, are embodied, wherein when executed by the at least one processor, the program instructions cause the at least one processor to:
receive, at at least one server from at least one vDAS compute node, periodic capacity usage reports for at least one virtualized distributed antenna system (vDAS) including at least one vDAS container operating on a first subset of a plurality of cores of the at least one vDAS compute node;
compare scaling metric data derived from the periodic capacity usage reports to threshold limits to determine if any of the threshold limits have been reached by any of the scaling metric data for the at least one vDAS compute node;
when any of the threshold limits have been reached by any of the scaling metric data for the at least one vDAS compute node:
causing the at least one vDAS compute node to scale capacity of the at least one vDAS compute node by either instantiating or deleting at least one additional vDAS container on a second subset of the plurality of cores of the at least one vDAS compute node.

18. The non-transitory processor-readable medium of claim 17, wherein:
the threshold limits include upper limits that, when exceeded, cause the at least one vDAS compute node to increase the capacity of the at least one vDAS compute node by instantiating the at least one additional vDAS container on the second subset of the plurality of cores of the at least one vDAS compute node; and
the upper limits include:
a first maximum number of cells for the at least one vDAS container;
a second maximum number of radio units (RUs) for the at least one vDAS container;
a maximum throughput for the at least one vDAS container; and
a maximum processing load of cores for the at least one vDAS container.

19. The non-transitory processor-readable medium of claim 17, wherein:
the threshold limits include lower limits that, when not met, cause the at least one vDAS compute node to decrease the capacity of the at least one vDAS compute node by deleting the at least one additional vDAS container on the second subset of the plurality of cores of the at least one vDAS compute node; and
the lower limits include:
a first minimum number of cells for the at least one vDAS container;
a second minimum number of radio units (RUs) for the at least one vDAS container;
a minimum throughput for the at least one vDAS container; and
a minimum processing load of cores for the at least one vDAS container.

20. The non-transitory processor-readable medium of claim 17, wherein causing the at least one vDAS compute node to scale the capacity of the at least one vDAS compute node occurs through at least one of scaling using a monolithic service architecture or scaling using micro-services architecture.
